(19) United States
(12) Patent Application Publication
(10) Pub. No.: US 2025/0122070 A1
(43) Pub. Date: Apr. 17, 2025

(54) SYSTEM AND METHOD FOR CONVEYING AND DISPENSING WATER

(71) Applicant: EFRAIM SHMUEL, JERUSALEM (IL)

(72) Inventor: EFRAIM SHMUEL, JERUSALEM (IL)

(21) Appl. No.: 18/914,335

(22) Filed: Oct. 14, 2024

(30) Foreign Application Priority Data
Oct. 17, 2023 (IL) 307810

(51) Int. Cl. B67D 1/08; B67D 1/00

(52) U.S. Cl. CPC B67D 1/0895; B67D 1/0014; B67D 1/0888; B67D 2210/00102

(57) ABSTRACT

A water dispenser for dispensing at least hot water for hot drinks, the water dispenser comprising: a water inlet; a hot water tank, connected to said water inlet via a first connection, for storing water from the water inlet; a heater associated with said hot water tank for heating the water in the hot water tank; a hot water outlet for dispensing hot water; a controller for controlling the operation of the water dispenser in 3 operation modes: a regular mode in which the heater operates as required and the water inlet supplies water to the hot water tank as required; a shabbat mode activated during shabbat hours in which the water inlet cannot supply water to the hot water tank; a festival day activated on a festival non-shabbat day, in which the water inlet is open only at predefined times.

### FIELD OF THE INVENTION

The subject matter generally relates to dispensing and heating water.

### BACKGROUND OF THE INVENTION

Water dispensers provides available water consumed for drinking, cleaning, and also in industries, for example for sanitation. According to Jewish religious regulations, heating is considered as labor and cannot be done on Saturdays and holidays. However, hot water is still needed, mainly for drinking hot beverages such as tea and coffee.

Some solutions to provide hot water on Saturdays and holidays require constant heating, for example by placing a container on a low-power heating device. The heating device may be connected to the gas grid or to the power grid. This solution consumes a lot of energy and does not consider actual demand. For example, it also provides hot water at night, when most people are asleep.

Other religious regulations forbid people from consuming water which was heated in the same container in which the water is poured to the users' glasses or bowls. Hence, there is a need to heat water in other containers, which are not the containers from which the water is dispensed to the users' cups/bowls/glasses.

### SUMMARY OF THE INVENTION

The subject matter discloses a water dispenser for dispensing at least hot water for hot drinks, the water dispenser comprising: a water inlet; a hot water tank, connected to said water inlet via a first connection, for storing water from the water inlet; a heater associated with said hot water tank for heating the water in the hot water tank; a hot water outlet for dispensing hot water; a controller for controlling the operation of the water dispenser in 3 operation modes. The operation modes include: 1. A regular mode in which the heater operates as required and the water inlet supplies water to the hot water tank as required. 2. A shabbat mode that is activated during shabbat hours in which the water inlet cannot supply water to the hot water tank. 3. A festival day that is activated on a festival non-shabbat day, in which the water inlet is open only at predefined times.

In some cases, the water dispenser further comprises a user interface physically coupled to a body of the water dispenser and electrically coupled to the controller, wherein the predefined times are inputted into the user interface.

In some cases, the water dispenser further comprises a communication unit configured to receive electric signals, wherein the predefined times are inputted into an electric device that sends signals to be received by the communication unit.

In some cases, the predetermined times are stored in a memory located inside the water dispenser. In some cases, the water inlet is open for a limited time duration during the predetermined times. In some cases, the water inlet is open for a limited amount of water flowing therethrough during the predetermined times. In some cases, the water inlet is open until the hot water tank is full for at least a predefined level during the predetermined times. In some cases, the water dispenser further comprises a clock coupled to the controller, said clock comprises data representing shabbat days and festival non-shabbat day.

The subject matter also discloses a method for operating a water dispenser having a hot water tank, a heater for heating the water in the hot water tank and a controller, the method comprises: operating the water dispenser in a regular mode in which a heater operates as required and the water inlet supplies water to the hot water tank as required; switching an operation mode from the regular mode to a shabbat mode in which the water inlet cannot supply water to the hot water tank; switching an operation mode from the regular mode to a festival mode in which the water inlet is open only at predefined times.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a water dispenser having a hot water tank and a cold water tank located below the water outlet, according to exemplary embodiments of the invention;

FIG. 2 shows a method for switching from one mode or operation of the water dispenser to another mode, according to exemplary embodiments of the subject matter;

### DETAILED DESCRIPTION

The subject matter described herein discloses a water dispensing system. The system comprises a hot water tank comprising hot water and a water outlet configured to provide the hot water to a consumer. The water dispenser is configured to provide water to consumers that follow Jewish regulations, for example, regulations in which during Shabbat days the water dispenser cannot heat water and water cannot enter the hot water tank from the water grid or from another water tank, while during holidays which are not Shabbat days water can enter the hot water tank, yet the water dispenser can only function using a mechanical way, without electricity. Known solutions to supply hot water during holidays include sensors that detect a water level in the hot water tanks, and when the amount of water in the hot water is below a threshold, open the water inlet.

The sensor requires maintenance, requires additional costs when designing and manufacturing water dispensers and hence there is a need to provide water dispensers without such sensors. The subject matter comprises a controller for controlling the flow of water into the hot water tank during holidays. The controller may be coupled to a clock 140 that stores the start time and end time of the holidays, in order to switch to the holiday mode of operation. During the holiday mode of operation or operation mode, the water inlet will be open during predetermined times only. Such predetermined times may be selected by a user of the water dispenser or by a manufacturer of the water dispenser. The system may comprise a controllable valve located between the water grid and the hot water tank. The controllable valve is configured to enable or disable the flow of water into the hot water tank. The controllable valve may move in response to receiving a command from the controller of the water dispensing system.

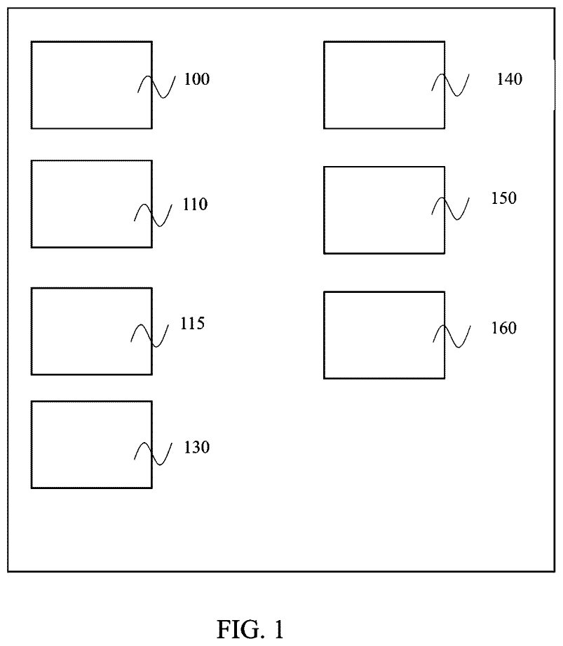

FIG. 1 shows a water dispenser having a hot water tank and a cold water tank located below the water outlet, according to exemplary embodiments of the invention. The hot water tank 110 and the cold water tank 115 may be placed inside a housing or mounted on a surface, such as a shelf or floor. The housing may be sealed to prevent access to the components located therein. The housing may have a base, sidewalls and a top cover.

The hot water tank 110 and the cold water tank 115 may be connected to a pressurized water source, such as a water grid 100, such that when the amount of water in one of the tanks 110, and 115 is lower than a threshold, water flows into the relevant tank. The hot water tank 110 and the cold water tank 115 may include sensors, for example for measuring biological, chemical, or physical properties of the water, such as an amount or concentration of a material in the water. The hot water tank 110 and the cold water tank 115 may comprise filters configured to filter materials from the water grid 100.

The water dispenser comprises a water inlet 130 configured to enable and disable flow of water into the hot water tank 110. Water may flow into the hot water tank 110 from the water grid or from another container. The water inlet 130 may be implemented as a controllable valve or another mechanism configured to block or allow the flow of water in a tube.

The water dispenser may comprise a control panel 160 used by persons to input commands on non-shabbat days. The control panel may comprise buttons, knobs, or a touch-operated input unit used to input commands into the water dispenser 100. The commands may include requests for cold water, lukewarm water, hot water, requests for various amounts of water, and the like.

The subject matter comprises a controller for controlling the flow of water into the hot water tank during holidays. The controller may be coupled to a clock that stores the start time and end time of the holidays and Shabbat days. In some cases, the controller may receive signals from a remote device that stores or has access to the start time and end time of the holidays and Shabbat days, such as an online server. The controller may be coupled to a memory storage used to store information. Such information may include a set of rules used by the controller to control the flow of water into the hot water tank during the 3 operation modes—regular mode, Shabbat mode and holiday mode.

The water dispenser may comprise a user interface user interface physically coupled to a body of the water dispenser and electrically coupled to the controller, wherein the predefined times are inputted into the user interface. The user interface may be a control panel coupled to the body of the water dispenser, for example to a front part of the water dispenser's housing. The user dispenser may be implemented as a computer software operating on an electronic device such as a cellular phone or laptop, and being connected to the controller, for example using a communication unit 150 in the water dispenser, such as an internet gateway, a wireless antenna, USB port and the like.

The water dispenser may comprise a clock 140 and electric circuitry for storing times that represent start time and time of the Shabbat days and holidays, such as Passover, Rosh Hashana, and additional holidays. The memory may store start dates of two subsequent days in case the holiday is celebrated outside Israel. This may be implemented by having a GPS in the water dispenser or by changing definitions of the water dispenser. For example, the water dispenser may have a first set of rules when installed in Israel and a second set of rules when installed outside Israel, and the controller will switch into the holiday mode for 2 days when the water dispenser system is installed outside Israel.

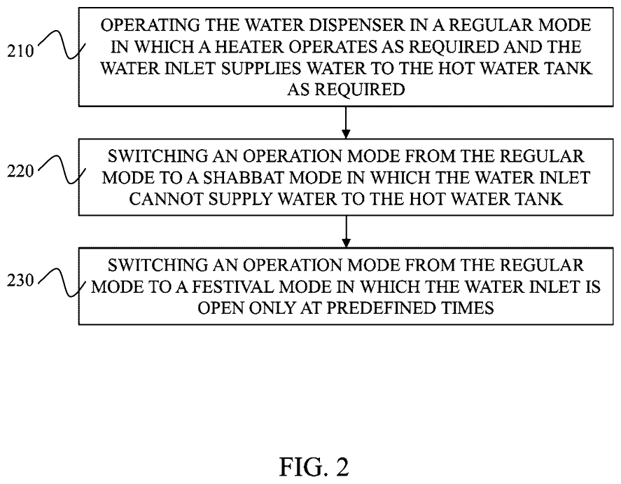

FIG. 2 shows a method for operating a water dispenser having a hot water tank, a heater for heating the water in the hot water tank and a controller, according to exemplary embodiments of the subject matter. In step 210, the method discloses operating the water dispenser in a regular mode in which a heater operates as required and the water inlet supplies water to the hot water tank as required. That is, the heater may heat the water in predetermined intervals, or operate in response to a demand from the user, for example when the user presses or moves an input unit such as a button, switch, knob, touch-activated display device, and the like. During regular mode, the water inlet is open and supplies water as requested into the hot water tank, for example when the water level is lower than a threshold, after supplying two cups of hot water or in response to another event desired by a person skilled in the art.

In step 220, the method discloses switching an operation mode from the regular mode to a shabbat mode in which the water inlet cannot supply water to the hot water tank. The switching may be done in response to a signal from a clock contained in the water dispenser or otherwise coupled to the controller. The clock may store times in which the shabbat days start and end for long periods of time, for example, several years. The clock may be part of a website from which the controller receives signals that represent the time. The water inlet may be disabled by closing a controllable valve that enables or disables passage of water from the water grid into the hot water tank, or using another controlled device or mechanism selected by a person skilled in the art. The closing may be done using an electric device such as a solenoid.

In step 230, the method discloses switching an operation mode from the regular mode to a festival mode in which the water inlet is open only at predefined times. The switching may be performed using the techniques described with regard to the shabbat mode or using other techniques, methods and devices selected by a person skilled in the art, as long as the mode is clearly defined. The predetermined times may be stored in a memory located inside the water dispenser, or in a memory accessible to the controller, for example on a web server or another remote device communicating with the controller over a communication channel or protocol. The predetermined times may be defined as specific times, for example, 6 AM, 3 AM, or another time during the holiday. The predetermined times may be inputted into a user interface physically coupled to a body of the water dispenser and electrically coupled to the controller. The user interface may be a control panel of the water dispenser. The predefined times may be inputted into an electric device that sends signals to be received by a communication unit 150 of the water dispenser, said communication unit 150 is configured to receive electric signals and transfer the signals to a memory accessible to the controller. During the holiday mode, the water inlet may be open for a limited time duration, for example, 2 minutes. In some cases, during the holiday mode, the water inlet is open for a limited amount of water flowing therethrough during the predetermined times. In some cases, during the holiday mode, the water inlet is open until the hot water tank is full for at least a predefined level during the predetermined times. In some cases, the system comprises a sensor configured to sense the amount of water in the hot water tank such that during festival mode the water inlet is closed when the amount of water in the hot water tank is higher than a threshold.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the invention. To the extent that section headings are used, they should not be construed as necessarily limiting.

What is claimed is:

1. A water dispenser for dispensing at least hot water for hot drinks, the water dispenser comprising:
a water inlet;
a hot water tank, connected to said water inlet via a first connection, for storing water from the water inlet;
a heater associated with said hot water tank for heating the water in the hot water tank;
a hot water outlet for dispensing hot water;
a controller for controlling the operation of the water dispenser in 3 operation modes:
a regular mode in which the heater operates as required and the water inlet supplies water to the hot water tank as required;
a shabbat mode activated during shabbat hours in which the water inlet cannot supply water to the hot water tank;
a festival day activated on a festival non-shabbat day, in which the water inlet is open only at predefined times.

2. The water dispenser of claim 1, further comprises a user interface physically coupled to a body of the water dispenser and electrically coupled to the controller, wherein the predefined times are inputted into the user interface.

3. The water dispenser of claim 1, further comprises a communication unit configured to receive electric signals, wherein the predefined times are inputted into an electric device that sends signals to be received by the communication unit.

4. The water dispenser of claim 1, wherein the predetermined times are stored in a memory located inside the water dispenser.

5. The water dispenser of claim 1, wherein the water inlet is open for a limited time duration during the predetermined times.

6. The water dispenser of claim 1, wherein the water inlet is open for a limited amount of water flowing therethrough during the predetermined times.

7. The water dispenser of claim 1, wherein the water inlet is open until the hot water tank is full for at least a predefined level during the predetermined times.

8. The water dispenser of claim 1, further comprises a clock coupled to the controller, said clock comprises data representing shabbat days and festival non-shabbat day.

9. A method for operating a water dispenser having a hot water tank, a heater for heating the water in the hot water tank and a controller, the method comprises:
operating the water dispenser in a regular mode in which a heater operates as required and the water inlet supplies water to the hot water tank as required;
switching an operation mode from the regular mode to a shabbat mode in which the water inlet cannot supply water to the hot water tank;
switching an operation mode from the regular mode to a festival mode in which the water inlet is open only at predefined times.
